(19) United States
(12) Patent Application Publication
(10) Pub. No.: US 2025/0012754 A1
(43) Pub. Date: Jan. 9, 2025

(54) CROWN ETHER-BASED ELECTROCHEMICAL NANO-SENSOR FOR SELECTIVE QUANTIFICATION OF SODIUM AND POTASSIUM IONS

(71) Applicant: CENTRAL LABS-KING KHALID UNIVERSITY, Abha (SA)

(72) Inventors: Anuj KUMAR, Mathura (IN); Mohd UBAIDULLAH, Ludhiana (IN); Mohd ABOHASAN, Abha (SA); Mohd SHKIR, Abha (SA); Mohammed S. ALQAHTANI, Abha (SA); Hamed Majdooa ALGARNI, Abha (SA); Yufeng ZHAO, Shanghai (CN)

(73) Assignee: CENTRAL LABS-KING KHALID UNIVERSITY, Abha (SA)

(21) Appl. No.: 18/895,140

(22) Filed: Sep. 24, 2024

(51) Int. Cl. G01N 27/327

(52) U.S. Cl. CPC G01N 27/3271

(57) ABSTRACT

The present invention relates to an electrochemical sensor for rapid and accurate detection of Na+ and K+ ions in the human body. The sensor utilizes a crown-ether functionalized graphene-based electrode, developed through innovative synthetic strategies. The process involves engineering graphene with highly selective crown ethers, resulting in a biocompatible, high-quality electrode. This sensor exhibits superior potentiometric detection capabilities for Na+ and K+ ions in extremely small samples. The invention offers a low-cost, highly sensitive, and selective method for monitoring ion concentrations, addressing the need for early identification of diseases caused by Na+/K+ imbalances. Benefits include rapid testing, versatility, and potential applications in personalized medicine and point-of-care diagnostics. This technology overcomes existing obstacles in early disease detection and provides a foundation for advanced biosensor development in healthcare.

### FIELD OF THE INVENTION

The present disclosure relates to fabrication process of crown ether based electrochemical nano-sensor for the selective quantification of sodium and potassium ions.

### BACKGROUND OF THE INVENTION

The use of electrochemical sensors in the medical field for testing various blood samples to quantify the sodium and potassium ions (Na+ and K+ electrolytes) is of paramount importance in clinical diagnostics. Concentration imbalance of electrolytes is initial indication of many diseases like dehydration (muscle crampon and reduction in athletic performance), anorexia, bulimia, hyper tension, diabetes, AIDS, and carcinoma etc. Sodium ions are the most abundant alkali metal ions present in human sweat (20-80 mM), approximately 10 times as compared to potassium ions (4-8 mM), being a biomarker for dehydration. The factors, monitoring and replacement of Na+ in athletes, are critical steps which can affect the rehydration of electrolytes. Na+ ion's concentration in sweat is a biomarker for cystic fibrosis, therefore, the monitoring Na+ levels in biological fluids is of great interest to the medical community.

Electrolyte balance in sweat can be efficiently measured by designing of selective biosensors as evident by the reports available by monitoring Na+ level in sweat. A Na+ sensor, an ion selective electrode based on the sodium ionophore calix [4] arene, was used to detect Na+ in the range of 10-100 mM. Further, a Na+/K+ sweat sensors, also an ionophore-based ISE, was fabricated on a wearable “tattoo” style associated with electrochemical cell. This sensor was capable to detect Na+ below 1 mM having potential for contact with skin or in the fabrication of method for wireless communication with the sensors. However, these technologies are still time consuming and costly.

Besides, confocal fluorescence microscopy (CFM) is a potential technique to detect any alteration in K+ ion concentrations with large spatial and temporal fidelity. Potassium-binding benzofuran isophthalate (PBFI) was utilized as an intracellular fluorescent K+ probe, using adiaz-18-crown-6 and benzofuran as a ligand fluorophore, respectively. However, PBFI has shown to have poor selectivity for Na+.

On the other hand, the development of nanomaterials has enabled flexible and stretchable electronics for sensing propose in past decades. Therefore, nano materials assumed to be well suited to meet the demands of sensors, having superior material properties (e.g., mechanical, electrical, optoelectronic) to their bulk counterparts. Such properties make nanomaterials compatible with scalable manufacturing of sensors, electronic devices etc.

In addition to that crown ethers are reported to selectively adsorb the many s-block metal ions due to presence of polar cavity consisting of O-, N- and S-donor atoms. HSAB theory suggests that a high charge density (hard bases) is capable of interacting with high charge density ions like Li+ (hard acids). Therefore, O-atom would have stronger interaction with ions than N- and S-atoms. In addition, quantity as well as substituents on crown ring may initiate the selective adsorption property. Therefore, the specific host-guest interactions in the corresponding complexes of Na+ and K+ with typical crown ethers incorporated with nano-architectures can readily sense the electrolytes in biological fluids with high selectivity and sensitivity.

### SUMMARY OF THE INVENTION

The present disclosure relates to a crown ether based electrochemical nano-sensor for the selective quantification of sodium and potassium ions. This invention presents a process for developing a crown-ether functionalized graphene-based electrode for use in an electrochemical sensor. The sensor is designed to accurately measure the concentrations of Na+ and K+ ions in very small samples. The electrode demonstrates superior performance in the potentiometric detection of these ions, offering a rapid, low-cost, and efficient method for monitoring Na+ and K+ levels in the human body. This technology has potential applications in early disease identification and diagnosis, particularly for conditions caused by imbalances in Na+ and K+ concentrations.

The present disclosure seeks to provide a composition for synthesizing graphene composites functionalized with crown ether. The composition comprises: 15-25 mg of graphene; 35-45 mL of deionized water; 10-20 mL of dimethylformamide; 0.10-0.20 mmol of triethylamine; 0.10-0.20 mmol of N-(3-dimethylaminopropyl)-N-ethylcarbodiimide hydrochloride; 0.10-0.20 mmol of hydroxyl benzotriazole (HOBt); a catalytic quantity of 4-dimethylaminopyridine (DMAP); and 0.10-0.20 mmol of 2-aminomethyl-18-crown-6.

In embodiment, the weight amount graphene, deionized water, an dimethylformamide, triethylamine, N-(3-dimethylaminopropyl)-N-ethylcarbodiimide hydrochloride, hydroxyl benzotriazole (HOBt), 4-dimethylaminopyridine (DMAP), and 2-aminomethyl-18-crown-6 is, 20 mg, 40 mL, 15 mL, 0.14 mmol, 0.14 mmol, 0.14 mmol, and 0.12 mol, respectively.

The present disclosure also seeks to provide method for synthesizing a graphene composite functionalized with crown ether for detecting sodium and potassium ions. The method comprises: (a) dissolving 15-25 mg of graphene in 35-45 mL of deionized water; (b) adding 10-20 mL of dimethylformamide to the graphene solution to obtain a mixture; (c) treating the mixture with 0.10-0.20 mmol of triethylamine and 0.10-0.20 mmol of N-(3-dimethylaminopropyl)-N-ethylcarbodiimide hydrochloride; (d) allowing the mixture to stand at room temperature for 15 minutes with stirring; (c) adding 0.10-0.20 mmol of hydroxyl benzotriazole (HOBt) and a catalytic quantity of 4-dimethylaminopyridine (DMAP) to the mixture; (f) stirring the mixture for an additional hour; (g) adding 0.10-0.20 mol of 2-aminomethyl-18-crown-6 to the solution; (h) stirring the solution at room temperature for four days; (i) diluting the resulting suspension with deionized water; (j) purifying the suspension using dialysis bags with a molecular weight cutoff of 12 KDa; and (k) drying the purified suspension under vacuum at 60° C.

In an embodiment, the graphene concentration is 20 mg in 40 mL of deionized water, wherein the dimethylformamide concentration is 15 mL.

In an embodiment, the method further comprises detecting sodium and potassium ions using graphene composite functionalized with crown ether, comprising: preparing a biological fluid sample; performing potentiometric measurements in the ion concentration range of 1 to 1000 mM at pH 7 upon immersing a sensor electrode and a reference electrode in the biological fluid sample; wherein the sensor electrode is fabricated by disposing of a crown ether functionalized graphene layer developed on the conductive layer; recording electrochemical signals received from the sensor electrode and reference electrode using a potentiometric sensor, thereby converting electrochemical signals into electrical signals by a transducer; and measuring a concentration of Na+ and K+ ions based on the binding of the ions to the crown ether functionalized graphene layer using a processor.

In an embodiment, the biological fluid sample is human sweat.

In an embodiment, the method further comprises calibrating the sensor electrode using standard solutions of known sodium and potassium ion concentrations.

In an embodiment, the sensor electrode is drop-coated with the prepared material onto a carbon disc.

The present disclosure further seeks to provide a sensor for detecting Na+ and K+ ions. The sensor comprises: a substrate; a conductive layer disposed on the substrate; a sensor electrode fabricated by disposing of a crown ether functionalized graphene layer developed on the conductive layer, wherein the crown ether functionalized graphene layer is configured to selectively bind Na+ and K+ ions; a reference electrode; a potentiometric sensor connected to the sensor electrode and the reference electrode to record electrochemical signals received from the sensor electrode and reference electrode; a transducer configured to convert electrochemical signals into electrical signals; and a processor configured to measure a concentration of Na+ and K+ ions based on the binding of the ions to the crown ether functionalized graphene layer.

In an embodiment, the crown ether is covalently bonded to the conductive layer disposed substrate, wherein the substrate is preferably of a carbon disc.

An objective of the present disclosure is to provide a composition and method for preparing crown ether based electrochemical nano-sensor for the selective quantification of sodium and potassium ions.

Another object of the present disclosure is to provide a suitable sensing device for the specific detection of Na+ and K+ ions in the human body.

Another object of the present disclosure is to design new facile and versatile synthetic strategies for graphene functionalized-crown ether engineering.

Another object of the present disclosure is to develop novel, highly selective and active crown ethers, functionalized with graphene, for use in electrochemical sensors for the rapid detection of Na+ and K+ ions in the human body.

Another object of the present disclosure is to ensure the feasibility of the developed materials for Na+/K+ sensing, with a focus on low cost, high sensitivity, and high selectivity.

Yet, another object of the present disclosure is to enable early identification and diagnosis of diseases caused by imbalances in Na+ and K+ levels through rapid and accurate ion detection.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a flow chart of a method for synthesizing a graphene composite functionalized with crown ether for detecting sodium and potassium ions in accordance with an embodiment of the present disclosure;

FIG. 2 illustrates a block diagram of the sensor for detecting Na+ and K+ ions in accordance with an embodiment of the present disclosure;

FIG. 3 illustrates Fabrication of highly selective and active crown-ether functionalized graphene-based electrode for the rapid detection of Na+ and K+ ions in human body;

FIG. 4 illustrates a graph showing Potentiometric tests of crown-ether functionalized graphene-based electrode towards K+ ions with different concentrations in accordance with an embodiment of the present disclosure;

FIG. 5 illustrates a graph showing Potentiometric tests of crown-ether functionalized graphene-based electrode towards Na+ ions with different concentrations in accordance with an embodiment of the present disclosure;

FIG. 6 illustrates a graph showing EIS measurements for crown ethers, graphene, and crown-ether functionalized graphene-based electrodes in accordance with an embodiment of the present disclosure; and

FIG. 7 illustrates a graph showing Reliability of the crown-ether functionalized graphene-based electrode material in two different tests in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

The present invention provides a composition for synthesizing graphene composites functionalized with crown ether, comprising: 15-25 mg of graphene; 35-45 mL of deionized water; 10-20 mL of dimethylformamide; 0.10-0.20 mmol of triethylamine; 0.10-0.20 mmol of N-(3-dimethylaminopropyl)-N-ethylcarbodiimide hydrochloride; 0.10-0.20 mmol of hydroxyl benzotriazole (HOBt); a catalytic quantity of 4-dimethylaminopyridine (DMAP); and 0.10-0.20 mmol of 2-aminomethyl-18-crown-6.

In an embodiment, the weight amount graphene, deionized water, dimethylformamide, triethylamine, N-(3-dimethylaminopropyl)-N-ethylcarbodiimide hydrochloride, hydroxyl benzotriazole (HOBt), 4-dimethylaminopyridine (DMAP), and 2-aminomethyl-18-crown-6 is, 20 mg, 40 mL, 15 mL, 0.14 mmol, 0.14 mmol, 0.14 mmol, . . . and 0.12 mol, respectively.

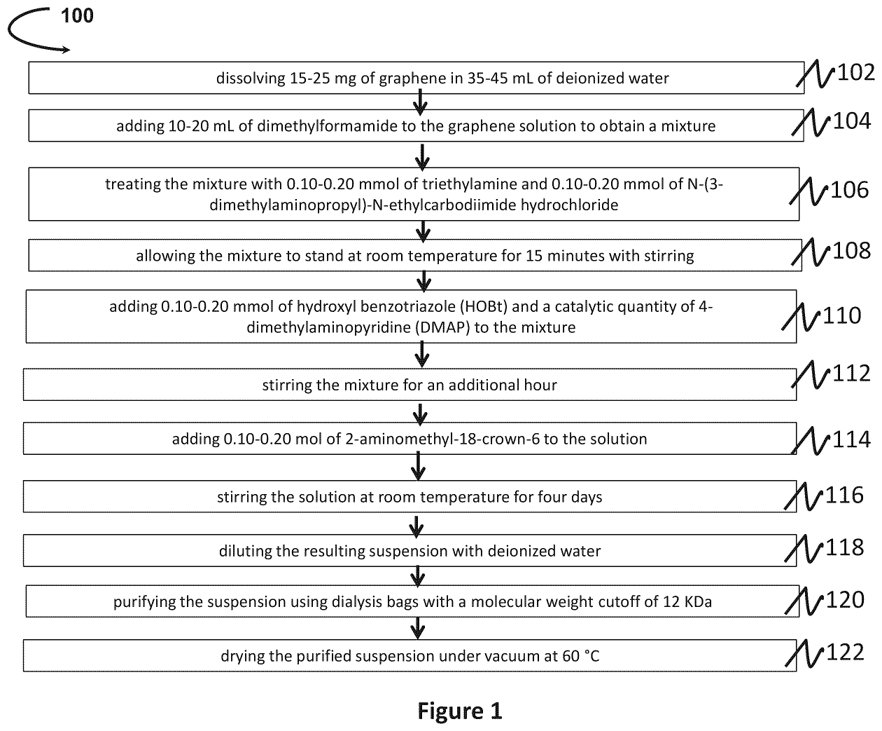

FIG. 1 illustrates a flow chart of a method (100) for synthesizing a graphene composite functionalized with crown ether for detecting sodium and potassium ions in accordance with an embodiment of the present disclosure.

Referring to FIG. 1, the method (100) includes a plurality of steps as described below.

At step (102), the method (100) includes dissolving 15-25 mg of graphene in 35-45 mL of deionized water.

At step (104), the method (100) includes adding 10-20 mL of dimethylformamide to the graphene solution to obtain a mixture.

At step (106), the method (100) includes treating the mixture with 0.10-0.20 mmol of triethylamine and 0.10-0.20 mmol of N-(3-dimethylaminopropyl)-N-ethylcarbodiimide hydrochloride.

At step (108), the method (100) includes allowing the mixture to stand at room temperature for 15 minutes with stirring.

At step (110), the method (100) includes adding 0.10-0.20 mmol of hydroxyl benzotriazole (HOBt) and a catalytic quantity of 4-dimethylaminopyridine (DMAP) to the mixture.

At step (112), the method (100) includes stirring the mixture for an additional hour.

At step (114), the method (100) includes adding 0.10-0.20 mol of 2-aminomethyl-18-crown-6 to the solution.

At step (116), the method (100) includes stirring the solution at room temperature for four days.

At step (118), the method (100) includes diluting the resulting suspension with deionized water.

At step (120), the method (100) includes purifying the suspension using dialysis bags with a molecular weight cutoff of 12 KDa.

At step (122), the method (100) includes drying the purified suspension under vacuum at 60° C.

In an embodiment, the graphene concentration is 20 mg in 40 mL of deionized water, wherein the dimethylformamide concentration is 15 mL.

In an embodiment, the method further comprises detecting sodium and potassium ions using graphene composite functionalized with crown ether, comprising: preparing a biological fluid sample; performing potentiometric measurements in the ion concentration range of 1 to 1000 mM at pH 7 upon immersing a sensor electrode and a reference electrode in the biological fluid sample; wherein the sensor electrode is fabricated by disposing of a crown ether functionalized graphene layer developed on the conductive layer; recording electrochemical signals received from the sensor electrode and reference electrode using a potentiometric sensor, thereby converting electrochemical signals into electrical signals by a transducer; and measuring a concentration of Na+ and K+ ions based on the binding of the ions to the crown ether functionalized graphene layer using a processor.

In an embodiment, the biological fluid sample is human sweat.

In an embodiment, the method further comprises calibrating the sensor electrode using standard solutions of known sodium and potassium ion concentrations.

In an embodiment, the sensor electrode is drop-coated with the prepared material onto a carbon disc.

In an embodiment, step (102) further comprises performing sonication of the graphene solution in an ultrasonic bath for a period of 30-45 minutes at a frequency of 42 kHz and a power density of 100-150 W/L to achieve exfoliation of graphene layers, followed by centrifugation at 10,000 RPM for 15 minutes to remove any unexfoliated particles, thereby obtaining a uniformly dispersed graphene suspension, wherein step (106) involves adding a pre-activated mixture of triethylamine and N-(3-dimethylaminopropyl)-N-ethylcarbodiimide hydrochloride, where the activation is achieved by pre-stirring the mixture at 0° C. for 10 minutes in an ice bath to prevent the decomposition of the carbodiimide and to enhance the coupling efficiency with the carboxyl groups present on the graphene surface, and wherein the addition of hydroxyl benzotriazole (HOBt) and 4-dimethylaminopyridine (DMAP) in step (110) is carried out in the presence of a non-aqueous, oxygen-free environment maintained by continuous purging with argon gas to prevent oxidation and to promote efficient ester formation on the graphene surface, wherein the molar ratio of HOBt to DMAP is precisely controlled at 1:0.1 to optimize catalytic efficiency.

In an embodiment, the stirring process in step (112) is conducted in a programmable reactor with temperature and agitation controls, wherein the temperature is maintained at 27±0.5° C. with a stirring speed gradient programmed to incrementally increase from 400 RPM to 700 RPM over the duration of 60 minutes to enhance the molecular interaction between the functional groups of graphene and the crown ether, wherein, in step (114), the addition of 2-aminomethyl-18-crown-6 is performed using a syringe pump at a controlled flow rate of 0.5 mL/min under continuous stirring at 500 RPM, where the temperature of the reaction mixture is precisely maintained at 23±1° C., and the mixture is further subjected to intermittent sonication for 10 seconds every 15 minutes to ensure homogeneous dispersion and interaction of the crown ether molecules with the graphene surface, and wherein, during step (116), the four-day stirring process is performed in a closed, inert atmosphere chamber maintained at 0.5 bar pressure with nitrogen gas to prevent moisture absorption and potential degradation of the crown ether structure, wherein the solution pH is continuously monitored and adjusted to remain between 7.0 and 7.5 using a calibrated pH meter to maintain the optimal reaction environment.

In an embodiment, step (118) involves a two-step dilution process wherein the suspension is first diluted with deionized water to double its initial volume and then sonicated for 15 minutes to prevent agglomeration, followed by a second dilution to a final volume of 200 mL while maintaining continuous stirring at 300 RPM to ensure a stable and homogeneous suspension is prepared for dialysis, wherein the dialysis process in step (120) is performed using a dynamic dialysis setup where the suspension is circulated through a series of 12 KDa molecular weight cutoff dialysis bags positioned in a rotating drum, with continuous flow of deionized water at a rate of 10 ml/min to maximize removal of low molecular weight impurities and unreacted reagents over a period of 72 hours, and wherein the drying process in step (122) is performed using a programmable vacuum oven equipped with a moisture and solvent vapor detection system, where the temperature is gradually increased from room temperature to 60° C. over a period of 6 hours, followed by a steady-state vacuum drying at 60° C. and 0.05 mbar for 24 hours, ensuring complete removal of water and solvent molecules while preserving the structural integrity and functionality of the graphene composite.

In an embodiment, step (102) further comprises performing sonication of the graphene solution in an ultrasonic bath for a period of 30-45 minutes at a frequency of 42 kHz and a power density of 100-150 W/L to achieve exfoliation of graphene layers, followed by centrifugation at 10,000 RPM for 15 minutes to remove any unexfoliated particles, thereby obtaining a uniformly dispersed graphene suspension, wherein step (106) involves adding a pre-activated mixture of triethylamine and N-(3-dimethylaminopropyl)-N-ethylcarbodiimide hydrochloride, where the activation is achieved by pre-stirring the mixture at 0° C. for 10 minutes in an ice bath to prevent the decomposition of the carbodiimide and to enhance the coupling efficiency with the carboxyl groups present on the graphene surface, and wherein the addition of hydroxyl benzotriazole (HOBt) and 4-dimethylaminopyridine (DMAP) in step (110) is carried out in the presence of a non-aqueous, oxygen-free environment maintained by continuous purging with argon gas to prevent oxidation and to promote efficient ester formation on the graphene surface, wherein the molar ratio of HOBt to DMAP is precisely controlled at 1:0.1 to optimize catalytic efficiency.

In an embodiment, the stirring process in step (112) is conducted in a programmable reactor with temperature and agitation controls, wherein the temperature is maintained at 27±0.5° C. with a stirring speed gradient programmed to incrementally increase from 400 RPM to 700 RPM over the duration of 60 minutes to enhance the molecular interaction between the functional groups of graphene and the crown ether, and wherein, in step (114), the addition of 2-aminomethyl-18-crown-6 is performed using a syringe pump at a controlled flow rate of 0.5 mL/min under continuous stirring at 500 RPM, where the temperature of the reaction mixture is precisely maintained at 23±1° C., and the mixture is further subjected to intermittent sonication for 10 seconds every 15 minutes to ensure homogeneous dispersion and interaction of the crown ether molecules with the graphene surface.

In an embodiment, during step (116), the four-day stirring process is performed in a closed, inert atmosphere chamber maintained at 0.5 bar pressure with nitrogen gas to prevent moisture absorption and potential degradation of the crown ether structure, wherein the solution pH is continuously monitored and adjusted to remain between 7.0 and 7.5 using a calibrated pH meter to maintain the optimal reaction environment, and wherein step (118) involves a two-step dilution process wherein the suspension is first diluted with deionized water to double its initial volume and then sonicated for 15 minutes to prevent agglomeration, followed by a second dilution to a final volume of 200 mL while maintaining continuous stirring at 300 RPM to ensure a stable and homogeneous suspension is prepared for dialysis. In an embodiment, the dialysis process in step (120) is performed using a dynamic dialysis setup where the suspension is circulated through a series of 12 KDa molecular weight cutoff dialysis bags positioned in a rotating drum, with continuous flow of deionized water at a rate of 10 mL/min to maximize removal of low molecular weight impurities and unreacted reagents over a period of 72 hours.

In an embodiment, the step (102) further comprises adjusting the pH of the deionized water to 5.5 using dilute hydrochloric acid prior to dissolving the graphene, to enhance the exfoliation efficiency of the graphene flakes by promoting a slight acidic environment, which assists in preventing restacking of graphene layers and wherein step (106) is further characterized by the addition of a chelating agent, ethylenediaminetetraacetic acid (EDTA) in a concentration of 0.01-0.05 mM, to the mixture before the addition of triethylamine and N-(3-dimethylaminopropyl)-N-ethylcarbodiimide hydrochloride, to bind trace metal impurities and prevent any catalytic side reactions that could interfere with the functionalization process.

In an embodiment, the reaction mixture in step (110) is exposed to microwave irradiation at a frequency of 2.45 GHz with a power output of 150-300 W for a period of 10 minutes immediately after the addition of hydroxyl benzotriazole (HOBt) and 4-dimethylaminopyridine (DMAP), to accelerate the reaction kinetics and enhance the covalent attachment of crown ether moieties to the grapheme, and wherein step (112) further comprises subjecting the mixture to a constant magnetic field of 0.5-1.0 Tesla using neodymium magnets positioned around the reaction vessel to align the graphene sheets and enhance the anisotropic distribution of functional groups on the graphene surface.

In an embodiment, during step (114), the 2-aminomethyl-18-crown-6 is added under a controlled nitrogen flow environment at a rate of 50-100 mL/min to maintain an inert atmosphere and prevent oxidation, wherein the mixture is stirred using a high-shear mixer operating at 1,000-1,500 RPM for the first 24 hours to promote thorough mixing and facilitate crown ether functionalization.

In an embodiment, the resulting solution in step (116) is subjected to cyclic voltammetry analysis every 12 hours to monitor the electrochemical properties of the graphene composite and to ensure the progressive functionalization of the graphene by observing changes in the redox peaks corresponding to the crown ether moieties.

In an embodiment, step (118) further involves the addition of a stabilizing agent, such as polyvinylpyrrolidone (PVP) at a concentration of 0.1-0.2 mg/mL, to the diluted suspension to prevent agglomeration of the functionalized graphene particles and to stabilize the colloidal suspension prior to purification.

In an embodiment, the purification in step (120) is performed using a multi-stage tangential flow filtration (TFF) system equipped with a 12 KDa molecular weight cutoff membrane, wherein the suspension is passed through the TFF system at a transmembrane pressure of 1-2 bar and a flow rate of 5-10 mL/min, followed by diafiltration with deionized water to achieve a high degree of purification.

In an embodiment, in step (122), the vacuum drying process is further controlled by incorporating a temperature gradient profile where the drying temperature is incrementally raised in steps of 10° C. every 2 hours until reaching 60° C., while monitoring the weight loss of the sample to ensure gradual removal of moisture and solvents, preventing thermal degradation of the functionalized composite.

In an embodiment, the final graphene composite obtained after step (122) is subjected to X-ray photoelectron spectroscopy (XPS) to confirm the successful attachment of crown ether groups by analyzing the characteristic binding energy shifts in the carbon and nitrogen 1s core-level spectra, thereby validating the structural modification of the graphene surface.

In an embodiment, the sensor electrode surface is modified with a self-assembled monolayer (SAM) of thiol-terminated crown ether compounds prior to the deposition of the crown ether functionalized graphene layer, to enhance the binding affinity and specificity of the electrode for sodium and potassium ions.

In an embodiment, the potentiometric sensor described is further configured to operate in a differential mode, wherein a second reference electrode is used to compensate for potential drifts and environmental noise, thereby enhancing the accuracy and reliability of ion concentration measurements in dynamic biological fluids.

In an embodiment, the sensor electrode fabrication process includes a heat treatment step at 100-120° C. for 2-4 hours in an inert argon atmosphere to improve the adhesion of the crown ether functionalized graphene layer to the conductive substrate and to enhance the electrode's electrochemical stability.

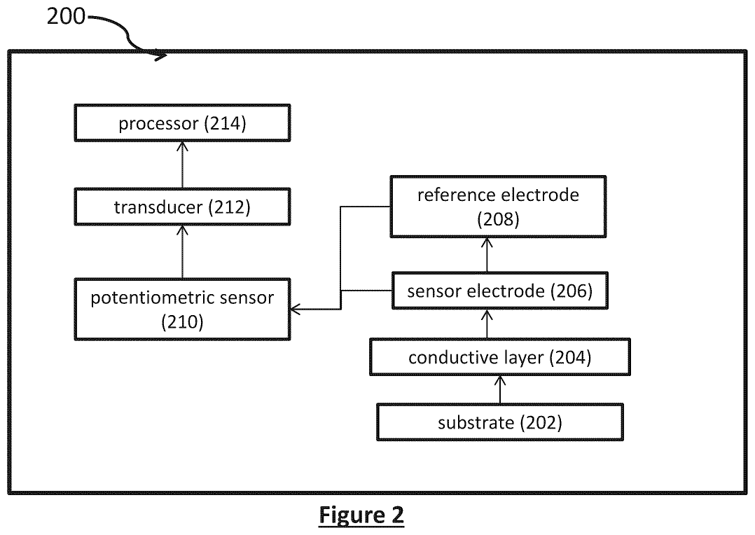

FIG. 2 illustrates a block diagram of the sensor (200) for detecting Na+ and K+ ions in accordance with an embodiment of the present disclosure.

Referring to FIG. 2, the sensor system (200) includes a substrate (202).

In an embodiment, a conductive layer (204) is disposed on the substrate (202).

In an embodiment, a sensor electrode (206) is fabricated by disposing of a crown ether functionalized graphene layer developed on the conductive layer (204), wherein the crown ether functionalized graphene layer is configured to selectively bind Na+ and K+ ions.

In an embodiment, the system (200) includes a reference electrode (208).

In an embodiment, a potentiometric sensor (210) is connected to the sensor electrode (206) and the reference electrode (208) to record electrochemical signals received from the sensor electrode (206) and reference electrode (208).

In an embodiment, a transducer (212) is configured to convert electrochemical signals into electrical signals.

In an embodiment, a processor (214) is configured to measure a concentration of Na+ and K+ ions based on the binding of the ions to the crown ether functionalized graphene layer.

In an embodiment, the crown ether is covalently bonded to the conductive layer disposed substrate, wherein the substrate is preferably of a carbon disc.

The present disclosure seeks to provide suitable sensing device to detect Na+ and K+ specifically in human body. The present process also discloses the design new facile and versatile synthetic strategies for the graphene functionalized-crown ether engineering. The present process also discloses the novel highly selective and active crown ethers, functionalized with graphene, based electro-chemical sensors for the rapid detection of Na+ and K+ ions in human body. The present process ensures the feasibility of developed materials for Na+/K+ sensing, formulating the low cost and high sensitivity and selectivity.

In an embodiment, step (102) further comprises performing sonication of the graphene solution in an ultrasonic bath for a period of 30-45 minutes at a frequency of 42 kHz and a power density of 100-150 W/L to achieve exfoliation of graphene layers, followed by centrifugation at 10,000 RPM for 15 minutes to remove any unexfoliated particles, thereby obtaining a uniformly dispersed graphene suspension, wherein step (106) involves adding a pre-activated mixture of triethylamine and N-(3-dimethylaminopropyl)-N-ethylcarbodiimide hydrochloride, where the activation is achieved by pre-stirring the mixture at 0° C. for 10 minutes in an ice bath to prevent the decomposition of the carbodiimide and to enhance the coupling efficiency with the carboxyl groups present on the graphene surface, and wherein the addition of hydroxyl benzotriazole (HOBt) and 4-dimethylaminopyridine (DMAP) in step (110) is carried out in the presence of a non-aqueous, oxygen-free environment maintained by continuous purging with argon gas to prevent oxidation and to promote efficient ester formation on the graphene surface, wherein the molar ratio of HOBt to DMAP is precisely controlled at 1:0.1 to optimize catalytic efficiency.

In an embodiment, the stirring process in step (112) is conducted in a programmable reactor with temperature and agitation controls, wherein the temperature is maintained at 27±0.5° C. with a stirring speed gradient programmed to incrementally increase from 400 RPM to 700 RPM over the duration of 60 minutes to enhance the molecular interaction between the functional groups of graphene and the crown ether, wherein, in step (114), the addition of 2-aminomethyl-18-crown-6 is performed using a syringe pump at a controlled flow rate of 0.5 mL/min under continuous stirring at 500 RPM, where the temperature of the reaction mixture is precisely maintained at 23±1° C., and the mixture is further subjected to intermittent sonication for 10 seconds every 15 minutes to ensure homogeneous dispersion and interaction of the crown ether molecules with the graphene surface, and wherein, during step (116), the four-day stirring process is performed in a closed, inert atmosphere chamber maintained at 0.5 bar pressure with nitrogen gas to prevent moisture absorption and potential degradation of the crown ether structure, wherein the solution pH is continuously monitored and adjusted to remain between 7.0 and 7.5 using a calibrated pH meter to maintain the optimal reaction environment.

In an embodiment, step (118) involves a two-step dilution process wherein the suspension is first diluted with deionized water to double its initial volume and then sonicated for 15 minutes to prevent agglomeration, followed by a second dilution to a final volume of 200 mL while maintaining continuous stirring at 300 RPM to ensure a stable and homogeneous suspension is prepared for dialysis, wherein the dialysis process in step (120) is performed using a dynamic dialysis setup where the suspension is circulated through a series of 12 KDa molecular weight cutoff dialysis bags positioned in a rotating drum, with continuous flow of deionized water at a rate of 10 mL/min to maximize removal of low molecular weight impurities and unreacted reagents over a period of 72 hours, and wherein the drying process in step (122) is performed using a programmable vacuum oven equipped with a moisture and solvent vapor detection system, where the temperature is gradually increased from room temperature to 60° C. over a period of 6 hours, followed by a steady-state vacuum drying at 60° C. and 0.05 mbar for 24 hours, ensuring complete removal of water and solvent molecules while preserving the structural integrity and functionality of the graphene composite.

In an embodiment, step (102) further comprises performing sonication of the graphene solution in an ultrasonic bath for a period of 30-45 minutes at a frequency of 42 kHz and a power density of 100-150 W/L to achieve exfoliation of graphene layers, followed by centrifugation at 10,000 RPM for 15 minutes to remove any unexfoliated particles, thereby obtaining a uniformly dispersed graphene suspension, wherein step (106) involves adding a pre-activated mixture of triethylamine and N-(3-dimethylaminopropyl)-N-ethylcarbodiimide hydrochloride, where the activation is achieved by pre-stirring the mixture at 0° C. for 10 minutes in an ice bath to prevent the decomposition of the carbodiimide and to enhance the coupling efficiency with the carboxyl groups present on the graphene surface, and wherein the addition of hydroxyl benzotriazole (HOBt) and 4-dimethylaminopyridine (DMAP) in step (110) is carried out in the presence of a non-aqueous, oxygen-free environment maintained by continuous purging with argon gas to prevent oxidation and to promote efficient ester formation on the graphene surface, wherein the molar ratio of HOBt to DMAP is precisely controlled at 1:0.1 to optimize catalytic efficiency.

In an embodiment, the stirring process in step (112) is conducted in a programmable reactor with temperature and agitation controls, wherein the temperature is maintained at 27±0.5° C. with a stirring speed gradient programmed to incrementally increase from 400 RPM to 700 RPM over the duration of 60 minutes to enhance the molecular interaction between the functional groups of graphene and the crown ether, and wherein, in step (114), the addition of 2-aminomethyl-18-crown-6 is performed using a syringe pump at a controlled flow rate of 0.5 mL/min under continuous stirring at 500 RPM, where the temperature of the reaction mixture is precisely maintained at 23±1° C., and the mixture is further subjected to intermittent sonication for 10 seconds every 15 minutes to ensure homogeneous dispersion and interaction of the crown ether molecules with the graphene surface.

In an embodiment, during step (116), the four-day stirring process is performed in a closed, inert atmosphere chamber maintained at 0.5 bar pressure with nitrogen gas to prevent moisture absorption and potential degradation of the crown ether structure, wherein the solution pH is continuously monitored and adjusted to remain between 7.0 and 7.5 using a calibrated pH meter to maintain the optimal reaction environment, and wherein step (118) involves a two-step dilution process wherein the suspension is first diluted with deionized water to double its initial volume and then sonicated for 15 minutes to prevent agglomeration, followed by a second dilution to a final volume of 200 mL while maintaining continuous stirring at 300 RPM to ensure a stable and homogeneous suspension is prepared for dialysis.

In an embodiment, the dialysis process in step (120) is performed using a dynamic dialysis setup where the suspension is circulated through a series of 12 KDa molecular weight cutoff dialysis bags positioned in a rotating drum, with continuous flow of deionized water at a rate of 10 mL/min to maximize removal of low molecular weight impurities and unreacted reagents over a period of 72 hours, and wherein step (102) further comprises adjusting the pH of the deionized water to 5.5 using dilute hydrochloric acid prior to dissolving the graphene, to enhance the exfoliation efficiency of the graphene flakes by promoting a slight acidic environment, which assists in preventing restacking of graphene layers and wherein step (106) is further characterized by the addition of a chelating agent, ethylenediaminetetraacetic acid (EDTA) in a concentration of 0.01-0.05 mM, to the mixture before the addition of triethylamine and N-(3-dimethylaminopropyl)-N-ethylcarbodiimide hydrochloride, to bind trace metal impurities and prevent any catalytic side reactions that could interfere with the functionalization process.

In an embodiment, the reaction mixture in step (110) is exposed to microwave irradiation at a frequency of 2.45 GHz with a power output of 150-300 W for a period of 10 minutes immediately after the addition of hydroxyl benzotriazole (HOBt) and 4-dimethylaminopyridine (DMAP), to accelerate the reaction kinetics and enhance the covalent attachment of crown ether moieties to the grapheme, and wherein step (112) further comprises subjecting the mixture to a constant magnetic field of 0.5-1.0 Tesla using neodymium magnets positioned around the reaction vessel to align the graphene sheets and enhance the anisotropic distribution of functional groups on the graphene surface, and wherein, during step (114), the 2-aminomethyl-18-crown-6 is added under a controlled nitrogen flow environment at a rate of 50-100 mL/min to maintain an inert atmosphere and prevent oxidation, wherein the mixture is stirred using a high-shear mixer operating at 1,000-1,500 RPM for the first 24 hours to promote thorough mixing and facilitate crown ether functionalization.

In an embodiment, the resulting solution in step (116) is subjected to cyclic voltammetry analysis every 12 hours to monitor the electrochemical properties of the graphene composite and to ensure the progressive functionalization of the graphene by observing changes in the redox peaks corresponding to the crown ether moieties, wherein step (118) further involves the addition of a stabilizing agent, such as polyvinylpyrrolidone (PVP) at a concentration of 0.1-0.2 mg/mL, to the diluted suspension to prevent agglomeration of the functionalized graphene particles and to stabilize the colloidal suspension prior to purification, and wherein the purification in step (120) is performed using a multi-stage tangential flow filtration (TFF) system equipped with a 12 KDa molecular weight cutoff membrane, wherein the suspension is passed through the TFF system at a transmembrane pressure of 1-2 bar and a flow rate of 5-10 mL/min, followed by diafiltration with deionized water to achieve a high degree of purification.

In an embodiment, in step (122), the vacuum drying process is further controlled by incorporating a temperature gradient profile where the drying temperature is incrementally raised in steps of 10° C. every 2 hours until reaching 60° C., while monitoring the weight loss of the sample to ensure gradual removal of moisture and solvents, preventing thermal degradation of the functionalized composite.

In an embodiment, the sensor electrode surface is modified with a self-assembled monolayer (SAM) of thiol-terminated crown ether compounds prior to the deposition of the crown ether functionalized graphene layer, to enhance the binding affinity and specificity of the electrode for sodium and potassium ions, and wherein the sensor electrode fabrication process includes a heat treatment step at 100-120° C. for 2-4 hours in an inert argon atmosphere to improve the adhesion of the crown ether functionalized graphene layer to the conductive substrate and to enhance the electrode's electrochemical stability.

In an embodiment, during step (110), a graphene dispersion stabilizer such as cetyltrimethylammonium bromide (CTAB) is added at a concentration of 0.005-0.01 M to prevent graphene aggregation and enhance the effective surface area for subsequent chemical functionalization, followed by an additional washing step with ethanol to remove excess stabilizer.

In an embodiment, step (120) involves a two-stage purification process, where the initial dialysis is performed against a solution of 0.01 M sodium chloride to facilitate the removal of any ionic impurities, followed by a secondary dialysis against deionized water to eliminate residual salts, thereby achieving a high-purity graphene composite suspension.

In an embodiment, the method 100 further comprises a step of functionalizing the graphene composite with a silane coupling agent after step (122), wherein the dried graphene composite is dispersed in an anhydrous toluene solution containing 1-3% (v/v) 3-aminopropyltriethoxysilane (APTES) and refluxed at 110° C. for 4-6 hours to introduce amine groups onto the surface of the graphene, thereby enhancing the composite's chemical reactivity and compatibility for subsequent chemical modifications or sensor fabrication processes.

In an embodiment, the graphene composites functionalized with crown ether were synthesized in the following manner:

The standard procedure involved dissolving 20 mg of graphene in 40 mL of deionized water, adding 15 mL of dimethylformamide, and then treating the mixture with 0.14 mmol of triethylamine and 0.14 mmol of N-(3-dimethylaminopropyl)-N-ethylcarbodiimide hydrochloride before allowing it to stand at room temperature for 15 minutes of stirring. After adding hydroxyl benzotriazole (HOBt, 0.14 mmol) and a catalytic quantity of 4-dimethylaminopyridine (DMAP), the mixture was stirred for an extra hour. To make crown-ether functionalized graphene composites, 0.12 mmol of 2-aminomethyl-18-crown-6 was added to the solution, and it was left to stir at room temperature for four days. Diluting the resulting suspensions with deionized water and purifying them using dialysis bags with a molecular weight of 12 KDa was the next step. The washing solutions were then dried under a vacuum at 60° C.

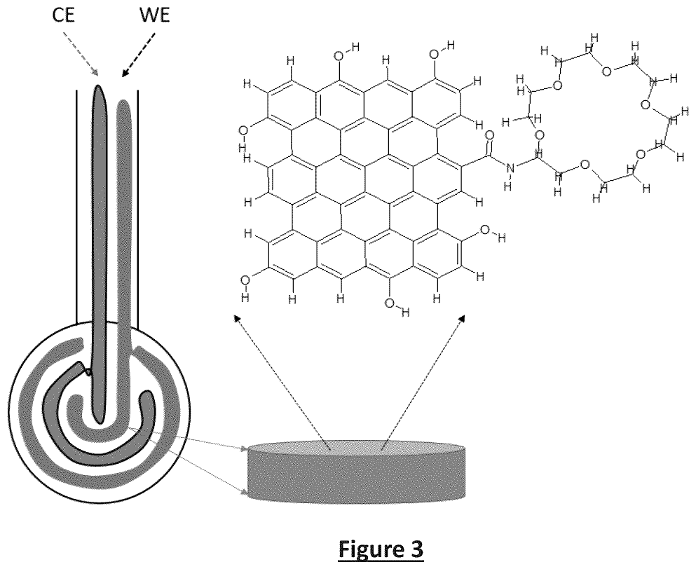

FIG. 3 illustrates Fabrication of highly selective and active crown-ether functionalized graphene-based electrode for the rapid detection of Na+ and K+ ions in human body.

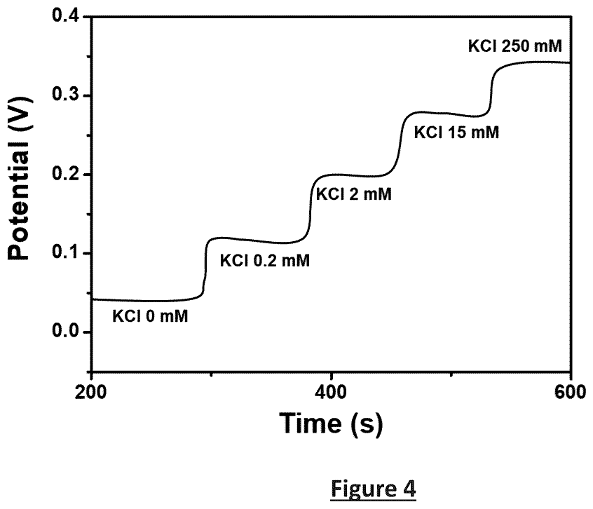

FIG. 4 illustrates a graph showing Potentiometric tests of crown-ether functionalized graphene-based electrode towards K+ ions with different concentrations in accordance with an embodiment of the present disclosure.

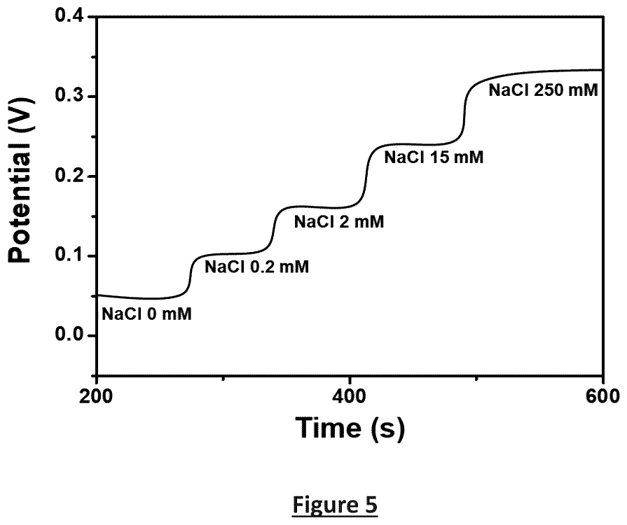

FIG. 5 illustrates a graph showing Potentiometric tests of crown-ether functionalized graphene-based electrode towards Na+ ions with different concentrations in accordance with an embodiment of the present disclosure.

The sensing performance of fabricated crown ethers graphene-based sensor was investigated by Potentiometric tests. Potentiometric tests have been performed in the Na+ and K+ concentrations range of 1 to 1000 mM in deionized water at pH 7. The working electrode were prepared by drop-coating the prepared material on carbon disc. FIG. 3 showed the fabricated device incorporated two electrodes for the Na+ and K+ ions detection. FIG. 4 and FIG. 5 showed the recorded electrochemical responses of the fabricated crown-ether graphene-based sensor towards K+ and Na+ ions, respectively, by immersing the electrode in potassium and sodium ion solutions of different concentrations.

These results indicated the sensitivity of fabricated electrodes towards the quantitative K+/Na+ determination. Further, to evaluate the selectively of prepared sensors, the chronoamperometry was used with an applied potential of +0.2 V for a fixed time period. The mechanism of ionic selectivity is based on facilitated transport of Na+ and K+ ions through the nanopores of crown ethers incorporated graphene. In polar solvents such as water, crown ethers are known to be selectively bind and release Na+ and K+ ions quickly, allowing for their transport, resulting the change in current and potential.

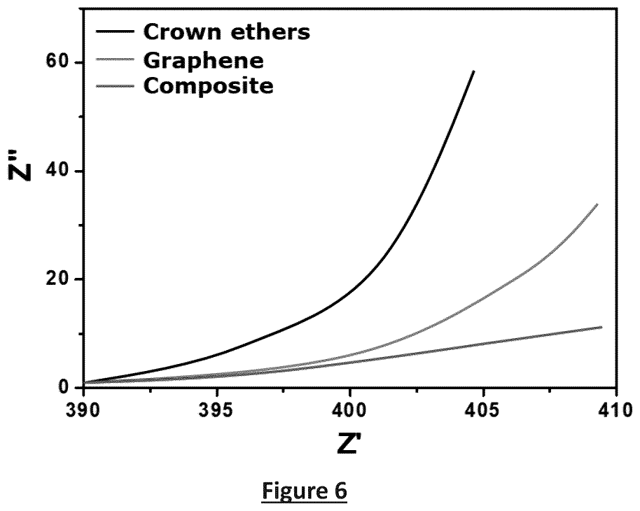

FIG. 6 illustrates a graph showing EIS measurements for crown ethers, graphene, and crown-ether functionalized graphene-based electrodes in accordance with an embodiment of the present disclosure.

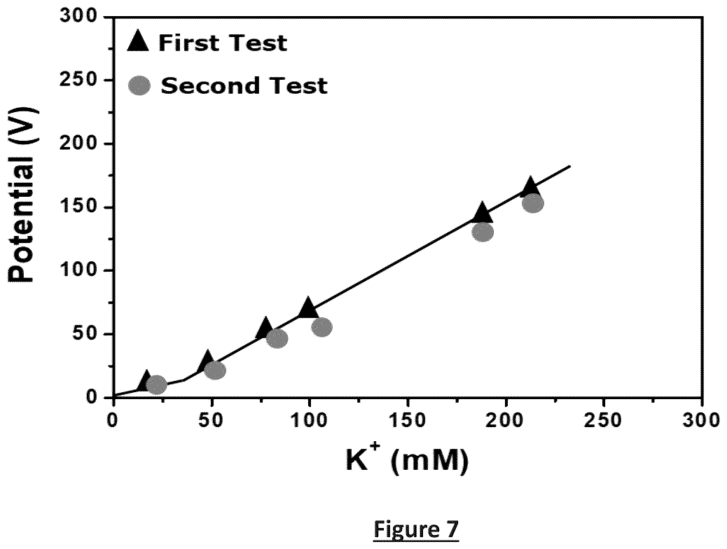

FIG. 7 illustrates a graph showing Reliability of the crown-ether functionalized graphene-based electrode material in two different tests in accordance with an embodiment of the present disclosure.

It was necessary to conduct EIS measurements in order to comprehend the manufactured material's electrochemical sensing mechanism. Crown-ether functionalized graphene-based electrode exhibit a significantly lower charge transfer resistance than bare graphene, indicating that they are more conductive and have a faster electron transfer rate. Referring to FIG. 6, the findings showed that the crown-ether functionalized graphene-based electrode worked better with the addition of graphene to the composite formulation. Although the crown ether moiety has a low conductivity, when functionalized with graphene, it shows a good charge transfer rate. This is a crucial parameter for improving the electrochemical sensor's performance. When we combine the EIS data with the potentiometric results, we find that the crown-ether functionalized graphene-based electrode respond well to changes in solution concentrations of Na+ and K+ ions. This is likely due to the complexation of these ions at the electrode-solution interface, which allows for fast electron transfer and transfer into the electrode surface. Multiple studies are conducted to assess the stability of the crown-ether functionalized graphene-based electrode. Referring to FIG. 7, it is discovered that the electrode's response remained very consistent across tests conducted on consecutive days.

In an embodiment, the electrodes can be used to make an electrochemical sensor that accurately measures the concentration of Na+ and K+ ions in extremely small samples. The crown-ether functionalized graphene-based electrode showed superior capabilities for potentiometric detection of Na+ and K+ ions in their performance.

### ACKNOWLEDGMENT

The authors extend their appreciation to the University Higher Education Fund for funding this research work under the Research Support Program for Central labs at King Khalid University through project number CL/PAT/5.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for synthesizing a graphene composite functionalized with crown ether for detecting sodium and potassium ions, comprising:
(a) dissolving 15-25 mg of graphene in 35-45 mL of deionized water;
(b) adding 10-20 mL of dimethylformamide to the graphene solution to obtain a mixture;
(c) treating the mixture with 0.10-0.20 mmol of triethylamine and 0.10-0.20 mmol of N-(3-dimethylaminopropyl)-N-ethylcarbodiimide hydrochloride;
(d) allowing the mixture to stand at room temperature for 15 minutes with stirring;
(e) adding 0.10-0.20 mmol of hydroxyl benzotriazole (HOBt) and a catalytic quantity of 4-dimethylaminopyridine (DMAP) to the mixture;
(f) stirring the mixture for an additional hour;
(g) adding 0.10-0.20 mol of 2-aminomethyl-18-crown-6 to the solution;
(h) stirring the solution at room temperature for four days;
(i) diluting the resulting suspension with deionized water;
(j) purifying the suspension using dialysis bags with a molecular weight cutoff of 12 KDa; and
(k) drying the purified suspension under vacuum at 60° C.

2. The method of claim 1, wherein the graphene concentration is 20 mg in 40 mL of deionized water, wherein the dimethylformamide concentration is 15 mL.

3. The method of claim 1, further comprises detecting sodium and potassium ions using graphene composite functionalized with crown ether, comprising:
performing potentiometric measurements in the ion concentration range of 1 to 1000 mM at pH 7 upon immersing a sensor electrode and a reference electrode in a biological fluid sample;
wherein the sensor electrode is fabricated by disposing of a crown ether functionalized graphene layer developed in claim 3 on the conductive layer;
recording electrochemical signals received from the sensor electrode and reference electrode using a potentiometric sensor, thereby converting electrochemical signals into electrical signals by a transducer; and
measuring a concentration of Na+ and K+ ions based on the binding of the ions to the crown ether functionalized graphene layer using a processor.

4. The method of claim 3, wherein the biological fluid sample is human sweat, wherein the sensor electrode is drop-coated with the prepared material onto a carbon disc, and wherein the crown ether is covalently bonded to the conductive layer disposed substrate, wherein the substrate is preferably of a carbon disc, and wherein the sensor electrode is calibrated using solutions of sodium and potassium ion concentrations.

5. The method of claim 1, wherein step (a) further comprises performing sonication of the graphene solution in an ultrasonic bath for a period of 30-45 minutes at a frequency of 42 kHz and a power density of 100-150 W/L to achieve exfoliation of graphene layers, followed by centrifugation at 10,000 RPM for 15 minutes to remove any unexfoliated particles, thereby obtaining a uniformly dispersed graphene suspension, wherein step (c) involves adding a pre-activated mixture of triethylamine and N-(3-dimethylaminopropyl)-N-ethylcarbodiimide hydrochloride, where the activation is achieved by pre-stirring the mixture at 0° C. for 10 minutes in an ice bath to prevent the decomposition of the carbodiimide and to enhance the coupling efficiency with the carboxyl groups present on the graphene surface, and wherein the addition of hydroxyl benzotriazole (HOBt) and 4-dimethylaminopyridine (DMAP) in step (e) is carried out in the presence of a non-aqueous, oxygen-free environment maintained by continuous purging with argon gas to prevent oxidation and to promote efficient ester formation on the graphene surface, wherein the molar ratio of HOBt to DMAP is precisely controlled at 1:0.1 to optimize catalytic efficiency.

6. The method of claim 1, wherein the stirring process in step (f) is conducted in a programmable reactor with temperature and agitation controls, wherein the temperature is maintained at 27±0.5° C. with a stirring speed gradient programmed to incrementally increase from 400 RPM to 700 RPM over the duration of 60 minutes to enhance the molecular interaction between the functional groups of graphene and the crown ether, wherein, in step (g), the addition of 2-aminomethyl-18-crown-6 is performed using a syringe pump at a controlled flow rate of 0.5 mL/min under continuous stirring at 500 RPM, where the temperature of the reaction mixture is precisely maintained at 23±1° C., and the mixture is further subjected to intermittent sonication for 10 seconds every 15 minutes to ensure homogeneous dispersion and interaction of the crown ether molecules with the graphene surface, and wherein, during step (h), the four-day stirring process is performed in a closed, inert atmosphere chamber maintained at 0.5 bar pressure with nitrogen gas to prevent moisture absorption and potential degradation of the crown ether structure, wherein the solution pH is continuously monitored and adjusted to remain between 7.0 and 7.5 using a calibrated pH meter to maintain the optimal reaction environment.

7. The method of claim 1, wherein step (i) involves a two-step dilution process wherein the suspension is first diluted with deionized water to double its initial volume and then sonicated for 15 minutes to prevent agglomeration, followed by a second dilution to a final volume of 200 mL while maintaining continuous stirring at 300 RPM to ensure a stable and homogenous suspension is prepared for dialysis, wherein the dialysis process in step (j) is performed using a dynamic dialysis setup where the suspension is circulated through a series of 12 KDa molecular weight cutoff dialysis bags positioned in a rotating drum, with continuous flow of deionized water at a rate of 10 mL/min to maximize removal of low molecular weight impurities and unreacted reagents over a period of 72 hours, and wherein the drying process in step (k) is performed using a programmable vacuum oven equipped with a moisture and solvent vapor detection system, where the temperature is gradually increased from room temperature to 60° C. over a period of 6 hours, followed by a steady-state vacuum drying at 60° C. and 0.05 mbar for 24 hours, ensuring complete removal of water and solvent molecules while preserving the structural integrity and functionality of the graphene composite.

8. The method of claim 1, wherein step (a) further comprises performing sonication of the graphene solution in an ultrasonic bath for a period of 30-45 minutes at a frequency of 42 kHz and a power density of 100-150 W/L to achieve exfoliation of graphene layers, followed by centrifugation at 10,000 RPM for 15 minutes to remove any unexfoliated particles, thereby obtaining a uniformly dispersed graphene suspension, wherein step (c) involves adding a pre-activated mixture of triethylamine and N-(3-dimethylaminopropyl)-N-ethylcarbodiimide hydrochloride, where the activation is achieved by pre-stirring the mixture at 0° C. for 10 minutes in an ice bath to prevent the decomposition of the carbodiimide and to enhance the coupling efficiency with the carboxyl groups present on the graphene surface, and wherein the addition of hydroxyl benzotriazole (HOBt) and 4-dimethylaminopyridine (DMAP) in step (e) is carried out in the presence of a non-aqueous, oxygen-free environment maintained by continuous purging with argon gas to prevent oxidation and to promote efficient ester formation on the graphene surface, wherein the molar ratio of HOBt to DMAP is precisely controlled at 1:0.1 to optimize catalytic efficiency.

9. The method of claim 1, wherein the stirring process in step (f) is conducted in a programmable reactor with temperature and agitation controls, wherein the temperature is maintained at 27±0.5° C. with a stirring speed gradient programmed to incrementally increase from 400 RPM to 700 RPM over the duration of 60 minutes to enhance the molecular interaction between the functional groups of graphene and the crown ether, and wherein, in step (g), the addition of 2-aminomethyl-18-crown-6 is performed using a syringe pump at a controlled flow rate of 0.5 mL/min under continuous stirring at 500 RPM, where the temperature of the reaction mixture is precisely maintained at 23±1° C., and the mixture is further subjected to intermittent sonication for 10 seconds every 15 minutes to ensure homogeneous dispersion and interaction of the crown ether molecules with the graphene surface.

10. The method of claim 1, wherein, during step (h), the four-day stirring process is performed in a closed, inert atmosphere chamber maintained at 0.5 bar pressure with nitrogen gas to prevent moisture absorption and potential degradation of the crown ether structure, wherein the solution pH is continuously monitored and adjusted to remain between 7.0 and 7.5 using a calibrated pH meter to maintain the optimal reaction environment, and wherein step (i) involves a two-step dilution process wherein the suspension is first diluted with deionized water to double its initial volume and then sonicated for 15 minutes to prevent agglomeration, followed by a second dilution to a final volume of 200 mL while maintaining continuous stirring at 300 RPM to ensure a stable and homogeneous suspension is prepared for dialysis.

11. The method of claim 1, wherein the dialysis process in step (j) is performed using a dynamic dialysis setup where the suspension is circulated through a series of 12 KDa molecular weight cutoff dialysis bags positioned in a rotating drum, with continuous flow of deionized water at a rate of 10 mL/min to maximize removal of low molecular weight impurities and unreacted reagents over a period of 72 hours, and wherein step (a) further comprises adjusting the pH of the deionized water to 5.5 using dilute hydrochloric acid prior to dissolving the graphene, to enhance the exfoliation efficiency of the graphene flakes by promoting a slight acidic environment, which assists in preventing restacking of graphene layers and wherein step (c) is further characterized by the addition of a chelating agent, ethylenediaminetetraacetic acid (EDTA) in a concentration of 0.01-0.05 mM, to the mixture before the addition of triethylamine and N-(3-dimethylaminopropyl)-N-ethylcarbodiimide hydrochloride, to bind trace metal impurities and prevent any catalytic side reactions that could interfere with the functionalization process.

12. The method of claim 1, wherein the reaction mixture in step (e) is exposed to microwave irradiation at a frequency of 2.45 GHz with a power output of 150-300 W for a period of 10 minutes immediately after the addition of hydroxyl benzotriazole (HOBt) and 4-dimethylaminopyridine (DMAP), to accelerate the reaction kinetics and enhance the covalent attachment of crown ether moieties to the grapheme, and wherein step (f) further comprises subjecting the mixture to a constant magnetic field of 0.5-1.0 Tesla using neodymium magnets positioned around the reaction vessel to align the graphene sheets and enhance the anisotropic distribution of functional groups on the graphene surface, and wherein, during step (g), the 2-aminomethyl-18-crown-6 is added under a controlled nitrogen flow environment at a rate of 50-100 ml/min to maintain an inert atmosphere and prevent oxidation, wherein the mixture is stirred using a high-shear mixer operating at 1,000-1,500 RPM for the first 24 hours to promote thorough mixing and facilitate crown ether functionalization.

13. The method of claim 1, wherein the resulting solution in step (h) is subjected to cyclic voltammetry analysis every 12 hours to monitor the electrochemical properties of the graphene composite and to ensure the progressive functionalization of the graphene by observing changes in the redox peaks corresponding to the crown ether moieties, wherein step (i) further involves the addition of a stabilizing agent, such as polyvinylpyrrolidone (PVP) at a concentration of 0.1-0.2 mg/mL, to the diluted suspension to prevent agglomeration of the functionalized graphene particles and to stabilize the colloidal suspension prior to purification, and wherein the purification in step (j) is performed using a multi-stage tangential flow filtration (TFF) system equipped with a 12 KDa molecular weight cutoff membrane, wherein the suspension is passed through the TFF system at a transmembrane pressure of 1-2 bar and a flow rate of 5-10 mL/min, followed by diafiltration with deionized water to achieve a high degree of purification.

14. The method of claim 1, wherein, in step (k), the vacuum drying process is further controlled by incorporating a temperature gradient profile where the drying temperature is incrementally raised in steps of 10° C. every 2 hours until reaching 60° C., while monitoring the weight loss of the sample to ensure gradual removal of moisture and solvents, preventing thermal degradation of the functionalized composite.

15. The method of claim 3, wherein the sensor electrode surface is modified with a self-assembled monolayer (SAM) of thiol-terminated crown ether compounds prior to the deposition of the crown ether functionalized graphene layer, to enhance the binding affinity and specificity of the electrode for sodium and potassium ions, and wherein the sensor electrode fabrication process includes a heat treatment step at 100-120° C. for 2-4 hours in an inert argon atmosphere to improve the adhesion of the crown ether functionalized graphene layer to the conductive substrate and to enhance the electrode's electrochemical stability.

16. The method of claim 1, wherein, during step (e), a graphene dispersion stabilizer such as cetyltrimethylammonium bromide (CTAB) is added at a concentration of 0.005-0.01 M to prevent graphene aggregation and enhance the effective surface area for subsequent chemical functionalization, followed by an additional washing step with ethanol to remove excess stabilizer.

17. The method of claim 1, wherein step (j) involves a two-stage purification process, where the initial dialysis is performed against a solution of 0.01 M sodium chloride to facilitate the removal of any ionic impurities, followed by a secondary dialysis against deionized water to eliminate residual salts, thereby achieving a high-purity graphene composite suspension.

18. The method of claim 1, further comprising a step of functionalizing the graphene composite with a silane coupling agent after step (k), wherein the dried graphene composite is dispersed in an anhydrous toluene solution containing 1-3% (v/v) 3-aminopropyltriethoxysilane (APTES) and refluxed at 110° C. for 4-6 hours to introduce amine groups onto the surface of the graphene, thereby enhancing the composite's chemical reactivity and compatibility for subsequent chemical modifications or sensor fabrication processes.

19. A composition formed using the method of claim 1, comprising:
20 mg of graphene;
40 mL of deionized water;
15-20 mL of dimethylformamide;
0.14 mmol of triethylamine;
0.14 mmol of N-(3-dimethylaminopropyl)-N-ethylcarbodiimide hydrochloride;
0.14 mmol of hydroxyl benzotriazole (HOBt); and
0.12-0.20 mmol of 2-aminomethyl-18-crown-6.
